(19) United States
(12) Patent Application Publication
(10) Pub. No.: US 2016/0347044 A1
(43) Pub. Date: Dec. 1, 2016

(54) Multi-Layered Metal

(71) Applicant: HEWLETT-PACKARD DEVELOPMENT COMPANY, L.P., Houston, TX (US)

(72) Inventors: WEI JEN CHEN, TAIPEI (TW); CHALAM KASHYAP, FORT COLLINS, CO (US); KUAN-TING WU, TAIPEI CITY (TW)

(21) Appl. No.: 14/911,281

(22) PCT Filed: Oct. 23, 2013
(86) PCT No.: PCT/US2013/066323

§ 371 Date: Apr. 30, 2015

(51) Int. Cl. B32B 37/10; B32B 37/06; B32B 15/04; B32B 37/14

(52) U.S. Cl. CPC B32B 37/10; B32B 37/14; B32B 37/06; B32B 15/043; B32B 2307/54; B32B 2311/00; B32B 2457/00

(57) ABSTRACT

A multi-layered metal includes a first layer, and a second layer on the first layer. The second layer is bonded to the first layer, by applying at least one of heat and pressure to an assembly including the first layer and the sheet to cause inter-metal diffusion between the first layer and the second layer.

### BACKGROUND

In various industries, lightweight materials are increasingly being used Products built using lightweight materials can be lighter than if made with heavier materials. Examples of products that can be built with lightweight materials include electronic devices, such as portable computers, desktop computers, smartphones, game appliances, or other types of electronic devices. Other types of products can also be built from lightweight materials.

### BRIEF DESCRIPTION OF THE DRAWINGS

Some implementations are described, with respect to the following figure

FIGS. 1 and 2 are cross-sectional views of a composite multi-layered metal, according to some implementations.

FIG. 3 is a cross-sectional view of a composite multi-layered metal according to alternative implementations.

FIGS. 4A-4C schematically illustrate a process of forming a composite multi-layered metal, according to some implementations.

FIG. 5 is a schematic diagram of a product built using a composite mutt layered metal, according to some implementations.

FIGS. 6 and 7 are flow diagrams of processes of forming a multi-layered metal, according to various implementations.

### DETAILED DESCRIPTION

Examples of lightweight metals that can be used to build products include magnesium alloys. A magnesium alloy includes a mixture of magnesium and other materials, such as aluminum, lithium, zinc, manganese, silicon, copper, niobium, rare earths, zirconium, and so forth. An issue associated with the use of a magnesium alloy is that the magnesium alloy may have certain characteristics that may not be optimal for certain applications. For example, a magnesium alloy may have relatively high porosity. The higher porosity of a magnesium alloy contributes to its being lightweight. However, increased porosity can lead to various issues. For example, it may be difficult to achieve good adhesion with a metal that has a higher porosity. Also, debris or particles may become trapped in the pores of a metal that has a higher porosity.

A magnesium alloy may also have lower tensile strength. Tensile strength refers to a maximum stress that a material can withstand while being stretched or pulled before the material fails or breaks. Moreover, a magnesium alloy may have a higher reactivity, which may cause the magnesium alloy to react with ambient air to form tenacious oxides, which can lead to corrosion.

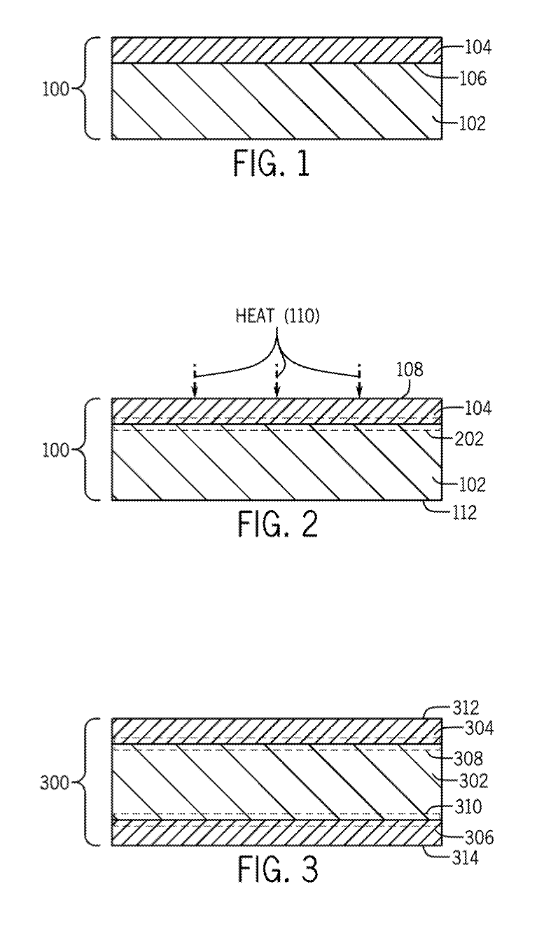

In accordance with some implementation, to address various issue associated with the use of a magnesium alloy, a composite multi-layered metal that includes multiple layers, in which one of the multiple layers includes a magnesium alloy layer, can be employed. FIG. 1 is a cross-sectional view of an example of a composite multi-layered metal 100. In the multi-layered metal 100, a first layer 102 can be formed of a material that includes a magnesium alloy. A second layer 104 includes a metal and is bonded to the first layer 102 at an interface 106.

In the example of FIG. 1, the second layer 104 is bonded to an upper surface of the first layer 102. In other examples, the second layer 104 can be bonded to a lower surface of the first layer 102. In alternative examples, the composite multi-layered metal 100 can include more than two layers, as discussed further below.

More generally, the second layer 104 is provided “on” the first layer 102. Providing the second layer 104 “on” the first layer 102 can refer to providing the second layer 104 in contact with the first layer 102, where the second layer 104 can be over, underneath, to one side, or have another orientation with respect to the first layer 102.

In some examples, the second layer 104 can include an aluminum or aluminum alloy. In other examples, the second layer 104 can include a different type of metal.

In further examples, the first layer 102 can include a first type of a magnesium alloy, such as a magnesium-lithium alloy, and the second layer 104 can include a second type of magnesium alloy, such as an AZ31 alloy, AZ91 alloy, or other type of alloys.

AZ31 refers to a material that includes aluminum (as indicated by “A”) and zinc (as indicated by “Z”). The “31” in AZ31 indicates that the alloy includes 3% aluminum and 1% zinc. Similarly, an AZ91 alloy includes 9% aluminum and 1% zinc. In other examples, other types of metals can be included in the layers 102 and 104.

The second layer 104 includes a metal that has one or multiple characteristics that improve upon the characteristic(s) of the magnesium alloy layer 102 for certain applications. For example, the second layer 104 can include a metal that has lower porosity than the magnesium alloy layer 102, and/or have a higher tensile strength than the magnesium alloy layer 102. Alternatively, the second layer 104 can include a metal that is less reactive than the magnesium alloy layer 102.

More generally, the first layer 102 includes a material having at least one characteristic selected from among a porosity of greater than about 2% of pore volume to total volume. Pore volume refers to a volume of voids or pores. Porosity is the fraction of the pare volume to a total volume of a material. In some examples, the first layer 102 can have a porosity in the range of about 2% to about 5%. Moreover, the first layer 102 can have a tensile strength of less than or equal to about 150 megapascals (Mpa) (to within manufacturing tolerances). In addition, magnesium that can be included in the first layer 102 may have an oxidation potential (e.g. about 2.37 volts (V)) that is higher than the oxidation potential of aluminum (e.g. about 1.66 V). A higher oxidation potential indicates that the surface of a material is more reactive; in other words, the surface of this material tends to oxidize more as compared to the surface of a less reactive material. Generally, the first layer 102 may have an oxidation potential that is higher than the oxidation potential of the second layer 104.

The second layer 104 bonded to the first layer 102 includes a metal that, can have a reduced porosity (e.g. porosity of less than 2%) and/or a higher tensile strength (e.g. greater than 150 Mpa). As an example, a magnesium-lithium alloy included in the first layer 102 can have a tensile strength of about 150 Mpa, and an AZ91 alloy in the second layer 104 can have a greater tensile strength of about 190 Mpa. Moreover, as noted above, the second layer 104 can be less reactive than the first layer 102 (e.g. the oxidation potential of the second layer 104 is less than the oxidation potential of the first layer 102).

The second layer 104 provided on the first layer 102 can be in the form of a sheet. A “sheet” refers to a continuous piece of material that can be provided on the first layer 102 as one unit. Providing the sheet onto the first layer 102 “as a unit” or “as one unit” refers to providing the sheet as an integrated layer, as opposed to providing particles of the sheet onto the first layer 102 using some type of deposition. By employing a sheet as the second layer 104, more complex deposition techniques for depositing particles of the second layer 104 onto the first layer 102 do not have to be employed. For example, an electrodeposition technique for depositing the second layer 104 onto the first layer 102 does not have to be employed for depositing particles of the second layer 104 onto the first layer 102. Use of complex deposition techniques can lead to increased manufacturing complexities and increased costs.

The sheet 104 can be a metal plate or a metal foil, which can simply be placed onto the first layer 102 as a single unit. Once the sheet 104 is placed on the first layer 102, heat and/or pressure is applied to cause inter-metal diffusion to bond the first and second layers 102 and 104.

FIG. 2 schematically shows an inter-metal diffusion zone 202. Inter-metal diffusion refers to a process in which molecules of the first layer 102 enter into the second layer 104, and molecules of the second layer 104 enter into the first layer 102. The mixing of the molecules of the materials of the layers 102 and 104 in the inter-metal diffusion zone 202 continues until an equilibrium state is reached. This mixing (or diffusion) of the molecules of the layers 102 and 104 cause the layers 102 and 104 to bond together.

To cause inter-metal diffusion, heat can be applied to the top surface 108 of the second layer 104, as indicated by arrows 110. The heat is applied to the top surface 108 of the second layer 104 after the second layer 104 has been placed on the upper surface of the first layer 102. The heat applied to the top surface 108 of the second layer 104 is transferred through the thickness of the second layer 104 to an upper portion of the first layer 102, which can trigger the inter-metal diffusion process. In some examples, inter-metal diffusion between the first and second layers 102 and 104 can be triggered if the temperature of the first and second layers 102 and 104 exceeds about 150° Celsius.

Alternatively, or additionally, heat can be applied to the bottom surface 112 of the first layer 102. Furthermore, heat can be applied to the top surface 108 of the second layer 104 and the bottom surface 112 of the first layer 102 at the same time.

In addition to, or in place of, heating the layers 102 and 104 to cause inter-metal diffusion, pressure can be applied to the layer 104 and/or the layer 102 to cause the inter-metal diffusion. Pressure can be applied mechanically. For example, the first layer 102 can sit on a support structure (not shown in FIG. 2), and a pressure-application structure (not shown in FIG. 2) can be pressed against the top surface 108 of the second layer 104. The pressure-application structure can apply a downward force on the second layer 104. Alternatively, the support structure below the first layer 102 can apply an upward force on the first layer 102.

In other examples, pressure can be applied by increasing the pressure in a chamber in which the assembly of the first and second layers 102 and 104 is placed. Pressurized gas (e.g. an inert gas) can be introduced into the chamber to cause pressure to be applied to the first and second layers 102 and 104. In some examples, to cause inter-metal diffusion between the first and second layers 102 and 104, the applied pressure can be greater than about 50 psi (pounds per square inch).

FIG. 3 is a cross-sectional view of an alternative composite multi-layered metal 300, which includes three layers. The three layers include a magnesium alloy layer 302, a second layer 304 that is provided over the magnesium alloy layer 302, and a third layer 306 that is provided underneath the magnesium alloy layer 302. Effectively, the layers 304 and 306 sandwich the magnesium alloy layer 302, which is provided between the layers 304 and 306. In some examples, the layers 304 and 306 can include an aluminum or aluminum alloy layer. In other examples, other types of metals can be included in the layers 304 and 306. The metals in the layers 304 and 306 can be the same, or they can be different.

The bonding of the second layer 304 to the magnesium alloy layer 302 and the bonding of the third layer 306 to the magnesium alloy layer 302 is performed by using inter-metal diffusion in respective inter-metal diffusion zones 308 and 310. The inter-metal diffusion can be initiated by applying heat and/or pressure to the respective upper surface 312 of the layer 304 and the lower surface 314 of the third layer 306.

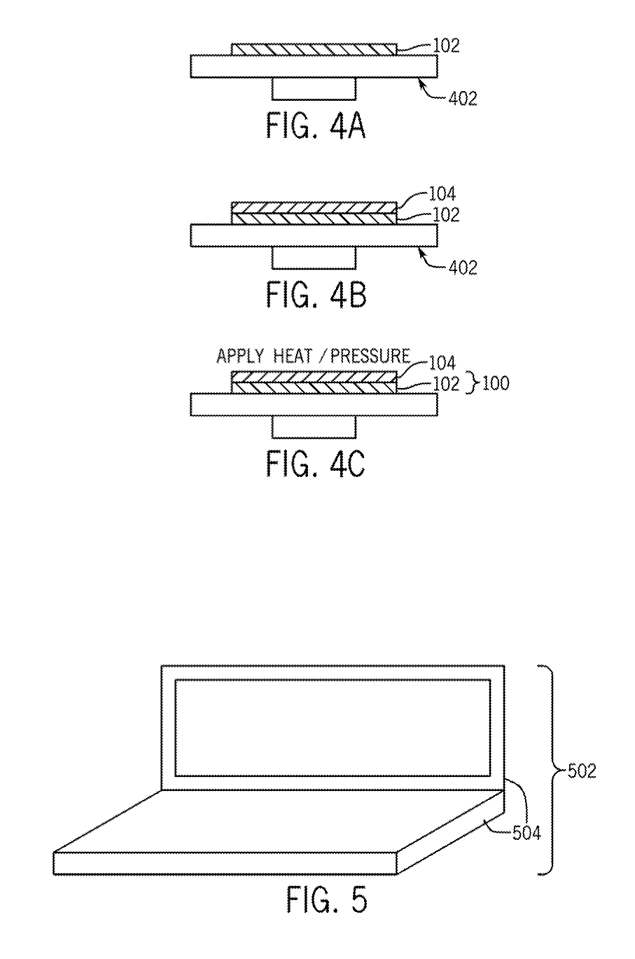

FIGS. 4A-4C schematically illustrate a process of forming the composite multi-layered metal 100, according to some implementations. In FIG. 4A, the first layer 102 is provided on a support structure 402, such as a base plate of other structure. The support structure 402 can be part of manufacturing equipment for building composite multi-layered metals according to some implementations.

Next, as shown in FIG. 46, the sheet 104 is provided on the first layer 102, where the sheet 104 can be placed on the first layer 102 by a human or by a machine. As noted above, placing the sheet 104 on the first layer 102 avoids having to perform deposition to deposit particles of the second layer 104 onto the first layer 102.

As shown in FIG. 4C, heat and/or pressure is applied to the assembly of the first layer 102 and the second layer 104, to cause bonding of the first and second layers 102 and 104 by inter-metal diffusion.

Additional processes can be performed on the composite multi-layered metal 100, which are not shown,

A similar process can be used to form the composite multi-layered metal 300, except that additional manufacturing tasks are performed to bond the three layers.

Once a composite multi-layered metal according to some implementations is formed, the metal can be used in forming a product. In some examples, the product formed can include a notebook computer 502, as shown in FIG. 5. The notebook computer 502 includes exterior housing(s) 504, which can be formed at least partially using the composite multi-layered metal. In further examples, internal components of the computer 502 can also be formed using the composite multi-layered metal.

Although FIG. 5 shows an example of building a computer using the composite multi-layered metal, it is noted that the composite multi-layered metal according to some implementations can be used to build other types of products, including smartphones, tablet computers, game appliances, and so forth. Additionally, the composite multi-layered metal can be used to build other types of products, such as cars, home appliances, and so forth.

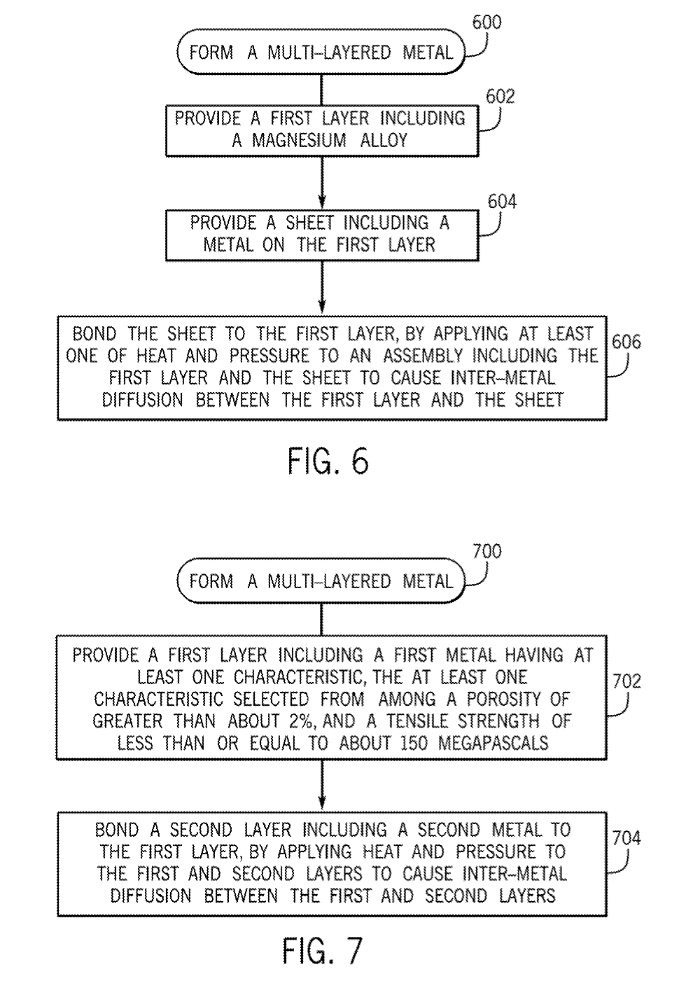

FIG. 6 is a flow diagram of a process 600 of forming a multi-layered metal, according to some implementations. The process 600 includes providing (at 602) a first layer including a magnesium alloy, and providing (at 604) a sheet including a metal on the first layer. The process 600 further includes bonding (at 606) the sheet to the first layer, by applying at least one of heat and pressure to an assembly including the first layer and the sheet to cause inter-metal diffusion between the first layer and the sheet.

FIG. 7 is a flow diagram of a process 700 of forming a multi-layered metal, according to alternative implementations. The process 700 includes providing (at 702) a first layer including a first metal having at least one characteristic, the at least one characteristic selected from among a porosity of greater than about 2%, and a tensile strength of less than or equal to about 150 megapascals. The process 700 further includes bonding (at 704) a second layer including a second metal to the first layer, by applying heat and pressure to the first and second layers to cause inter-metal diffusion between the first and second layers.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method of forming a multi-layered metal, comprising:
providing a first layer including a magnesium alloy;
providing a sheet including a metal on the first layer; and
bonding the sheet to the first layer, by applying at least one of heat and pressure to an assembly including the first layer and the sheet to cause inter-metal diffusion between the first layer and the sheet.

2. The method of claim 1, wherein applying the at least one of the heat and pressure is performed without performing electrodeposition of a material of the sheet on the first layer.

3. The method of claim 1, wherein the bonding is performed after providing the sheet on the first layer, wherein providing the sheet on the first layer comprises providing the sheet on an upper surface or a lower surface of the first layer.

4. The method of claim 1, wherein providing the sheet comprises providing one of a metal plate and a metal foil.

5. The method of claim 1, wherein the sheet includes aluminum or an aluminum alloy.

6. The method of claim 1, wherein the first layer includes a first type of magnesium alloy, and the sheet includes a second type of magnesium alloy.

7. The method of claim 1, wherein the metal of the sheet has at least one of the following characteristics: a lower porosity than the magnesium alloy of the first layer, a higher tensile strength than the magnesium alloy of the first layer, or a lower reactivity than the magnesium alloy of the first layer.

8. The method of claim 1, wherein the sheet is bonded to a first surface of the first layer, the method further comprising:
bonding another layer to a second, different surface of the first layer, by applying at least one of heat and pressure to cause inter-metal diffusion between the first layer and the another layer.

9. The method of claim 1, wherein the bonding is performed by applying both the heat and the pressure.

10. A method of forming a multi-layered metal, comprising:
providing a first layer including a first metal having at least one characteristic, the at least one characteristic selected from among a porosity of greater than about 2%, and a tensile strength of less than or equal to about 150 megapascals; and
bonding a second layer including a second metal to the first layer, by applying heat and pressure to the first and second layers to cause inter-metal diffusion between the first and second layers.

11. The method of claim 10, wherein the first metal includes magnesium.

12. The method of claim 10, wherein bonding the second layer comprises bonding a sheet to the first layer, wherein the sheet is provided on the first layer as a unit.

13. The method of claim 10, wherein the second metal has at least one of the following characteristics: a lower porosity than the first metal, a greater tensile strength than the first metal, or a lower reactivity than the first metal.

14. A multi-layered metal, comprising:
a first layer including a magnesium alloy; and
a sheet provided on a surface of the first layer as a unit and bonded to the first layer by inter-metal diffusion provided by application of at least one of heat and pressure to an assembly including the first layer and the sheet.

15. The multi-layered metal of claim 14, herein the sheet comprises one of a metal plate and a metal foil.
